(19) United States
(12) Patent Application Publication
(10) Pub. No.: US 2025/0272668 A1
(43) Pub. Date: Aug. 28, 2025

(54) TRANSFER GROUPS

(71) Applicant: Moov Financial, Inc, Cedar Falls, IA (US)

(72) Inventors: Wade Arnold, Golden, CO (US); Kolawole Awe, Brooklyn, NY (US); Komal Long, Lakeway, TX (US); Joshua Sadler, Phoenix, AZ (US); Charles Sander, San Francisco, CA (US)

(21) Appl. No.: 19/060,541

(22) Filed: Feb. 21, 2025

Related U.S. Application Data
(60) Provisional application No. 63/557,312, filed on Feb. 23, 2024.

(51) Int. Cl. G06Q 20/10

(52) U.S. Cl. CPC G06Q 20/10

(57) ABSTRACT

Aspects of the present disclosure relate to transfer grouping by a transfer platform. In examples, a request to initiate a transfer includes a source account, a destination account, and an amount. A request for a subsequent transfer may include an identifier corresponding to the first transfer instead of specifying a source account. Accordingly, the transfer platform determines that the first transfer and second transfer are each part of a transfer group, such that the second transfer is generated as a dependent transfer from the first transfer. As a result, once the first transfer is complete, the second transfer is automatically initiated due to the association that was formed between the first and second transfer.

### CROSS-REFERENCE TO RELATED APPLICATION

This application claims priority to U.S. Provisional Application No. 63/557,312, titled “Transfer Groups,” filed on Feb. 23, 2024, the entire disclosure of which is hereby incorporated by reference in its entirety.

### BACKGROUND

In examples, a transfer of a resource occurs from a source account to a destination account. However, there may be instances where the resource is further transferred from the destination account (e.g., thus acting as a source account) to yet another destination account as part of a second transaction. Traditionally, entry of the second transfer is only possible after completion of the first transfer, resulting in additional processing overhead, increased complexity, and the potential for human error, among other examples.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to transfer grouping by a transfer platform. In examples, a request to initiate a transfer includes a source account, a destination account, and an amount. However, in instances where the transfer is the first transfer of a series of transfers, a request for a subsequent transfer may include an identifier corresponding to the first transfer instead of specifying a source account. Thus, as a result of receiving a transfer identifier as the source for the transfer, the transfer platform determines that the first transfer and second transfer are each part of a transfer group, such that the second transfer may be generated as a dependent (e.g., child) transfer from the first transfer.

As a result, once the first transfer is complete, the second transfer is automatically initiated due to the association that was formed via the second transfer request. Any number of dependent or child transfers may thus be added to the transfer group, thereby enabling a user to define a chain of transfers that are automatically initiated accordingly once preceding, parent transfers are completed.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which a transfer platform may group a series of transfers according to aspects described herein.

FIG. 2 illustrates an overview of an example method for processing a request to generate a transfer according to aspects described herein.

FIG. 3A illustrates an overview of an example method for processing a transfer completion indication to initiate a child transfer according to aspects described herein.

FIG. 3B illustrates an overview of an example method for processing a transfer failure indication to cancel a child transfer according to aspects described herein.

FIG. 4 illustrates an overview an example method for generating a graphical visualization of a transfer group according to aspects described herein.

FIG. 5 illustrates an overview of an example process flow for transfer grouping according to aspects described herein.

FIG. 6 illustrates an example of a suitable operating environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a transfer platform provides an application programming interface (API) with which to manage transfers processed by the transfer platform. However, if multiple transfers are interrelated (e.g., a balance from a destination account of a first transfer is to subsequently be transferred to another destination account by a second transfer), the transfer platform may traditionally process an API call for the second transfer only after the first transfer has completed, thereby resulting in additional complexity for software that integrates with the transfer platform, the potential for unnecessary delays if the second transfer is not initiated upon completion of the first transfer, and wasted computing resources (e.g., as a result of additional processing to determine whether the first transfer has been completed such that the second transfer can be initiated), among other detriments.

Accordingly, aspects of the present disclosure relate to transfer grouping for transfers that are processed by a transfer platform. In examples, an API call that defines a transfer includes a source account, a destination account, and an amount. When the transfer platform processes the API call, a response may be generated that includes an identifier for the transfer. In instances where the transfer is the first transfer of a series of transfers, a subsequent API call (e.g., for a subsequent transfer) is made to the transfer platform. However, instead of specifying a source account (e.g., as was specified in the first API call), the second API call includes the received transfer identifier as the source, in addition to the destination account and the amount (similar to the first transfer). As a result of receiving a transfer identifier as the source for the transfer, the transfer platform determines that the first transfer and second transfer are each part of a transfer group, such that the second transfer may be generated as a dependent (e.g., child) transfer from the first transfer. As a result, once the first transfer is complete, the second transfer is automatically initiated as a result of the association that was formed via the second API call.

As a result, a series of API calls can be used to define a series of transfers, even though a preceding transfer of the series of transfers may not yet have been completed. It will be appreciated that any of a variety of transfer structures may be defined according to aspects described herein, including, but not limited to, a one-to-one transfer (e.g., a parent transfer having a single child transfer) and/or a one-to-many or transfer (e.g., a parent transfer having multiple child transfers), among other examples. Additionally, a series of transfers may include any number of transfers and/or depth of hierarchical levels, though it will be appreciated that such aspects may be artificially limited for technical considerations (e.g., reducing associated memory consumption) in some examples. As another example, a single API call may be used to define a series of transfers (e.g., where a subsequent transfer includes a reference to a preceding transfer), among other examples. In examples, an indication to generate a child transfer may be provided at any time (e.g., assuming the parent transfer has not yet failed and/or a resulting balance is sufficient to fulfil the child transfer, among other additional and/or alternative validation rules, as discussed below).

When an indication is received to generate a child transfer for a given parent transfer (e.g., via an API call that includes an existing transfer identifier, as discussed above), the transfer platform may evaluate a set of validation rules to determine whether the child transfer is to be generated. Example validation rules include, but are not limited to, determining whether an amount of the parent destination account (e.g., the child source account) is sufficient to perform the child transfer and evaluating whether the parent destination account was a transfer to an account outside of the transfer platform (e.g., an “exit” transfer, such that subsequent transfers via the transfer platform would not be possible), among other examples.

In some instances, a balance that results from a transfer may not be determinable prior to completion, such that a validation rule may instead rely on a worst-case scenario when validating a child transfer. As another example, a request to generate a transfer includes an indication as to a percentage of the remaining parent balance for subsequent transfer by the child transfer. As a further example, a user indicates (e.g., as a user preference or as part of a transfer request) that a child transfer should be performed even in instances where a resulting parent balance is insufficient, such that the insufficiency may be addressed by the user at a later time or against a user's deposit account, among other examples.

Additionally, it will be appreciated that, in some examples, a validation rule may apply to multiple transfers, for example to validate a series of transfers as a whole (also referred to herein as a transfer group). For instance, a validation rule may determine whether a transfer group includes an inflow that is sufficient to satisfy all subsequent outflows of the transfer group, such that an additional child transfer rule may not be permitted if the child rule exceeds the remaining net balance of the transfer group.

While examples are described in which an API call or other indication is used to generate a child transfer, it will be appreciated that, in other examples, a child transfer may automatically be generated. For instance, a transfer generation rule may be associated with a user, a transfer type, and/or a destination, such that a child transfer is generated automatically as a result of satisfying the transfer generation rule. As an example, as part of a revenue sharing agreement, a child transfer may automatically be generated as a result of an inflow that satisfies a corresponding transfer generation rule, such that a user need not manually provide an indication to generate the child transfer accordingly. Such aspects may be beneficial in instances where a similar set of child transfers are generated in response to an event and/or according to a predetermined schedule, among other examples. It will be appreciated that any number of child transfers (e.g., of the same parent transfer or off a subsequent child transfer) may be generated according to a transfer generation rule in other examples.

In examples, a given transfer has an associated state machine that defines various states for the transfer through its lifecycle. For example, a transfer that has been initiated but has not yet concluded may be in a “pending” state, whereas a transfer that has since terminated may be in a “completed” or “failed” state. Additionally, a transfer that has not yet been initiated (e.g., that depends on a preceding transfer according to aspects described herein) may be in a “queued” state. Thus, an example progression for a child transfer according to aspects described herein may be from queued, to pending, to either completed or failed. Fewer, additional, and/or any of a variety of other states may be used in other examples.

As used herein, a transfer may have one or more corresponding transactions, where each transaction advances the state of the transfer. For instance, a transfer may have one transaction between a source account and a destination account. As another example, an additional transaction may be included, which transfers a corresponding transaction fee from the source to another destination account. According to the disclosed aspects, sequential completion of all constituent transactions for a given transfer may thus cause the associated state machine to indicate the transfer has reached a terminal state (e.g., thereby further initiating a subsequent transfer, which may itself have one or more associated transactions).

Such a state machine may thus abstract away implementation-specific aspects for processing a transfer via any of a variety of transaction networks/processors (also referred to herein as “transaction agents”), thereby enabling the transfer platform to monitor the state of a number of transfers and perform subsequent processing (e.g., initiating a child transfer) without specifically accounting for idiosyncrasies of a transaction agent via which the transfers are ultimately affected.

As an example, a state machine according to aspects described herein may provide a framework for managing idiosyncrasies of various payment networks, for example to tailor “completion” criteria to align with a given risk tolerance. For instance, while a typical transaction (e.g., an ACH debit) might settle on the day after the transaction (T+1), a notification of insufficient funds (NSF) can potentially arrive anytime up until the third day (T+3). Absent such tailored completion criteria, a transfer may be designated as “complete” only after T+3 (e.g., after no NSF has been received), which may then thus trigger any related subsequent transfers according to aspects described herein. However, this setting may be modified by a user, for example to permit a transfer to be designated as complete prior to T+3 (or, as another example, as having failed in any of a variety of other scenarios). For example, the completion criterion may indicate a transfer as being “complete” at T+1, thereby accelerating the processing of the entire transfer series but also assuming the risk of NSF occurrences. Conversely, another user may extend this period to T+7, thereby providing additional time for notification of an unauthorized payment return before proceeding with a subsequent transfer. This flexibility in setting the completion timeline thus may enable users to balance processing speed with risk management considerations.

As a result of maintaining a state machine for a given transfer maintained by the transfer platform, the transfer platform performs subsequent processing as a result of a transfer reaching any of a variety of states. For example, as a result of determining a transfer has reached a “completed” state, it may be determined whether the transfer has one or more associated child transfers, such that a corresponding set of child transfers may subsequently be initiated. As another example, as a result of determining a transfer has reached a “failed” state, a set of associated child transfers may be identified, such that each child transfer is subsequently cancelled. Such a “completed” or “failed” states may be referred to as “terminal” states, such that the transfer platform processes associated child transfers as a result of identifying a “terminal” state. While example states and resulting actions are described, it will be appreciated that additional or alternative actions may be performed in other examples. For instance, a notification may be generated as a result of a failure state, which may be provided to a user to enable the user to attempt to remedy or mitigate the failed transfer and thus permit subsequent processing of the set of child transfers.

In examples, when a transfer group is generated, the transfer group is defined using the same identifier as the parent transfer specified by the transfer request (e.g., as the transfer source). Accordingly, a subsequent determination of whether there is a transfer group for the parent transfer comprises determining whether there is a transfer group having the identifier of the parent transfer. It will be appreciated that any of a variety of additional or alternative techniques may be used to associate a transfer and a transfer group, for example using a mapping generated in a relational and/or graph database.

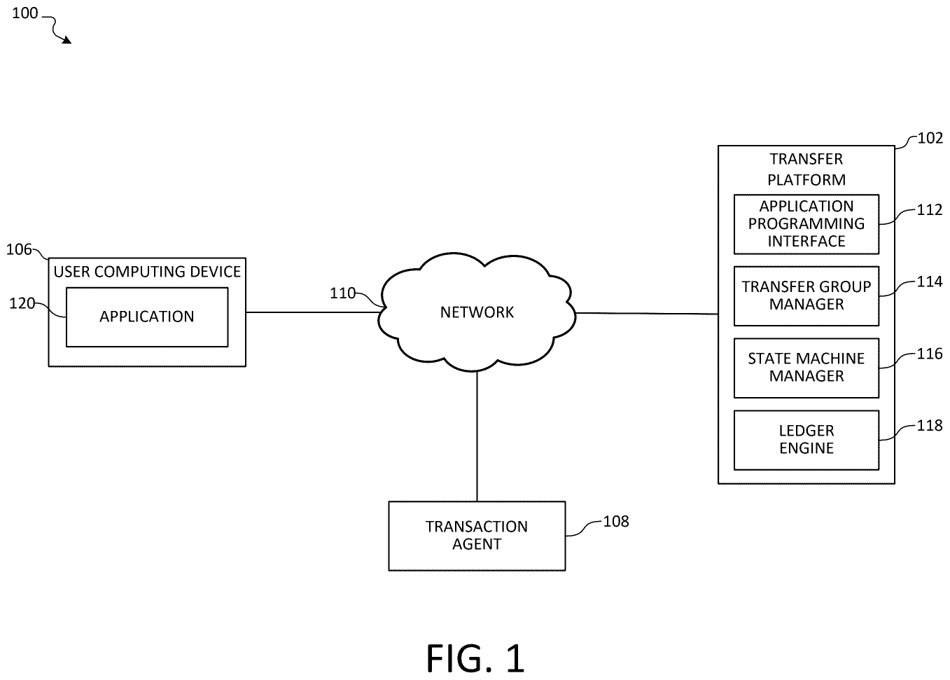

FIG. 1 illustrates an overview of an example system 100 in which a transfer platform may group a series of transfers according to aspects described herein. As illustrated, system 100 comprises transfer platform 102, resource manager 104, user computing device 106, transaction agent 108, and network 110.

In examples, transfer platform 102, resource manager 104, user computing device 106, and transaction agent 108 communicate via network 110. For example, network 110 may comprise a local area network, a wireless network, or the Internet, or any combination thereof, among other examples. Transfer platform 102, resource manager 104, user computing device 106, and transaction agent 108 may each be any of a variety of computing devices, including, but not limited to, a mobile computing device, a laptop computing device, a tablet computing device, a desktop computing device, a server computing device, and/or a distributed computing device comprised of a set of computing devices that provide the functionality described herein.

It will be appreciated that while system 100 is illustrated as comprising one transfer platform 102, one resource manager 104, one user computing device 106, and one transaction agent 108, any number of such elements may be used in other examples. Further, the functionality described herein may be distributed among or otherwise implemented on any number of different computing devices in any of a variety of other configurations in other examples.

As illustrated, transfer platform 102 comprises application programming interface 112, transfer group manager 114, state machine manager 116, and ledger engine 118. In examples, application programming interface 112 is used to request or otherwise manage a transfer and/or to access information from transfer platform 102 (e.g., relating to a transfer), among other examples. For example, application 120 of user computing device 106 uses application programming interface 112 to communicate with transfer platform 102 according to aspects described herein. While application programming interface 112 is illustrated separately from transfer group manager 114, state machine manager 116, and ledger engine 118, it will be appreciated that application programming interface 112 may be part of and/or may otherwise enable access to any of a variety of functionality of transfer group manager 114, state machine manager 116, and/or ledger engine 118.

Additionally, or alternatively, transfer group manager 114, state machine manager 116, and/or ledger engine 118 may use application programming interface 112 to interface with any of a variety of other elements of transfer platform 102. As another example, an event bus may be used to pass events and/or messages between transfer group manager 114, state manager 116, and/or ledger engine 118, among other examples.

Transfer platform 102 is further illustrated as comprising transfer group manager 114. In examples, transfer group manager 114 manages a transfer group of transfer platform 102. For example, transfer group manager 114 receives a request (e.g., via application programming interface 112) for which a transfer group is generated according to aspects described herein. As noted above, the request may include a source, a destination, and an amount, where the source includes an indication of an existing transfer (e.g., a transfer identifier).

Accordingly, transfer group manager 114 determines whether there is an existing transfer group or whether a new transfer group is to be generated. In examples, the determination comprises evaluating the identifier that was provided as the source for the transfer (also referred to herein as a source identifier) to determine whether the identifier corresponds to a transfer for which a transfer group exists. Thus, in examples where it is determined that a new transfer group is to be generated, the source identifier may also be used as an identifier for the resulting transfer group, thereby facilitating subsequent identification of the transfer group (e.g., when adding another transfer and/or when determining whether there is a subsequent transfer to process after a preceding transfer has reached a terminal state).

In examples, transfer group manager 114 manages execution of transfers for a given transfer group. For example, transfer group manager 114 receives an indication of a terminal state for a transfer (e.g., from state machine manager 116, discussed below), such that transfer group manager 114 identifies an associated transfer group (if available) and determines whether there are any subsequent (e.g., child) transfers to process. In examples, the indication is received via an event bus. If a subsequent transfer is identified, transfer group manager 114 may initiate the transfer (e.g., if the indication indicates that the parent transfer was successful) or may cancel the transfer (e.g., if the indication indicates that the parent transfer failed), among other examples. As noted above, a transfer may have any number of child transfers according to any of a variety of structures. As another example, if a grandparent transfer has two parent transfers that each have one or more child transfers, the child transfers need not be processed contemporaneously (e.g., a first parent transfer may be initiated and/or may be completed separately and/or with different timing as compared to a second parent transfer).

Transfer platform 102 is further illustrated as comprising state machine manager 116. In examples, state machine manager 116 maintains a state machine for transfers that are processed by transfer platform 102. As noted above, a transfer may have one or more corresponding transactions, such that state machine manager 116 monitors the status of each transaction to maintain a status for the transfer accordingly. In examples, transferring a resource for a transfer managed by transfer platform 102 is performed by a transaction agent, such as transaction agent 108. Example transaction agents include, but are not limited to, a payment platform, a payment network, or a payment processor. For instance, transaction agent 108 may include a credit card network and/or the automated clearing house (ACH) network, among other examples. As noted above, any number of transaction agents may be used, each of which may have an associated set of attributes. For example, a first transaction agent may have a longer processing time as compared to a second transaction agent. Accordingly, state machine manager 116 maintains a state for transfers even across various transaction agents, thereby providing a level of abstraction between processing performed by transfer platform 102 and the potential idiosyncrasies of the transaction agents that are used by transfer platform 102 to complete transfers. In examples, state machine manager 116 periodically polls a transaction agent for a transaction status and/or receives an indication from a transaction agent when there is a change to a transaction state, among other examples.

Finally, ledger engine 118 of transfer platform 102 maintains a ledger corresponding to transfers managed by transfer platform 102. In examples, the ledger stores data relating to inflows, outflows, and a current balance for a given account, thereby enabling transfer group manager 114 and state machine manager 116 to evaluate attributes of a given account (e.g., a source account and/or a destination account) when performing aspects described herein. For example, transfer group manager 114 evaluates a ledger managed by ledger engine 118 to determine whether to generate a transfer and/or when initiating a transfer (e.g., based on comparing a transfer balance to a transfer amount). As another example, the ledger is used when initiating a child transfer, for instance to determine a resulting balance of a source account after completion of a preceding transfer. The resulting balance may thus be used to validate that a sufficient balance is available for a child transfer and/or to determine a transfer amount in instances where the transfer amount is specified as a percentage rather than a numeric amount, among other examples.

System 100 is also illustrated as comprising user computing device 106. As noted above, application 120 of user computing device 106 may be used to communicate with transfer platform 102 (e.g., via application programming interface 112). While examples are described with respect to application programming interface 112, it will be appreciated that a web browser may additionally or alternatively be used in other examples. Additionally, while user computing device 106 is described as communicating with transfer platform 102 in the instant example, it will be appreciated that, in another example, a third-party service (not pictured) may additionally or alternatively communicate with transfer platform 102. For instance, the third-party service provides a website accessed by user computing device 106 (e.g., via application 120), and further communicates with transfer platform 102 (e.g., via application programming interface 112) to provide associated functionality of the website.

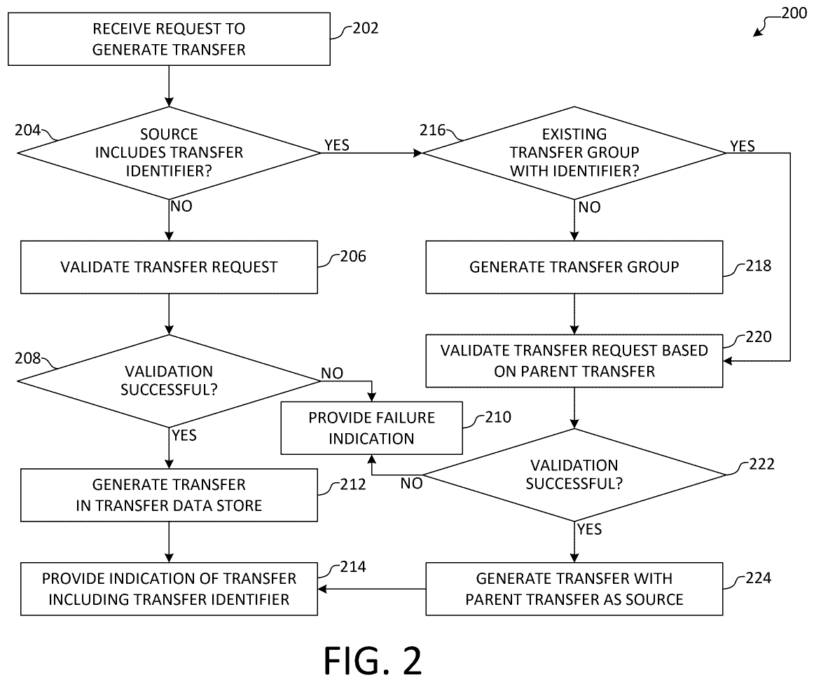

FIG. 2 illustrates an overview of an example method 200 for processing a request to generate a transfer according to aspects described herein. In examples, aspects of method 200 are performed by a transfer platform, such as transfer platform 102 in FIG. 1.

As illustrated, method 200 begins at operation 202, where a request to generate a transfer is received. In examples, the request is received via an API, such as application programming interface 112 discussed above with respect to FIG. 1. As noted above, the request may comprise an indication of a source (e.g., a source account and/or a transfer identifier), a destination, and an amount (e.g., as a numeric value or as a percentage). In examples, at least one of the source or the destination correspond to an account managed by the transfer platform. For instance, the request may be a request to transfer money to the transfer platform from an external account or to transfer money from the transfer platform to an external account. As another example, the request is to transfer money between accounts of the transfer platform. It will therefore be appreciated that any of a variety of transfer requests may be received.

Flow progresses to determination 204, where it is determined whether the source of the received transfer request includes a transfer identifier (e.g., of a parent transfer). According to aspects described herein, a source included in a request may indicate a source account or, as another example, may indicate a pre-existing parent transfer (e.g., as may have been generated as a result of a previous iteration of method 200), such that the destination account of the parent transfer is used as the source account accordingly. It will be appreciated that, while the present example is described as indicating the parent transfer using a transfer identifier for the parent transfer, any of a variety of other transfer indications may be used in other examples.

If it is determined that the source does not include a transfer identifier, flow branches “NO” to operation 206, where the transfer request is validated. In examples, such validation may be similar to the validation rules discussed above, where it is determined that the source account has a sufficient balance (e.g., as may be determined when the source account is an account of the transfer platform) to complete the requested transfer. It will be appreciated that any of a variety of additional or alternative validation operation may be performed in other examples.

Accordingly, at determination 208, it is determined whether validation was successful. In examples, operation 206 comprises the evaluation of multiple validation rules, such that it is determined that validation is successful at determination 208 as a result of all of the evaluated validation rules being satisfied. If it is determined that validation is not successful, flow branches “NO” and terminates at operation 210, where a failure indication is provided (e.g., in response to the request that was received at operation 202). In examples, the failure indication includes an error code and/or a reason why the transfer request failed (e.g., an indication as to a validation rule that was not satisfied).

By contrast, if it is instead determined that validation was successful, flow branches “YES” to operation 212, where a transfer record is generated in a transfer data store based on the request. In examples, operation 212 comprises generating a transfer identifier for the transfer, which may be a hash or a universally unique identifier (UUID), among other examples. The transfer record may thus be stored with or otherwise in association with the transfer identifier, thereby enabling subsequent retrieval of the transfer using the transfer identifier. In examples, the transfer record is generated within a relational database and/or a graph database. Additionally, a state machine may be initialized for the transfer (e.g., by a state machine manager, such as state machine manager 116 in FIG. 1), such that a state corresponding to the transfer is maintained for use by other processing performed by the transfer platform (e.g., generating reports, performing an operation in response to an event, etc.). Operation 212 may comprise initiating the transfer (e.g., via a transaction agent, such as transaction agent 104 in FIG. 1), thereby causing a state machine for the transfer to be in a “pending” state.

Flow progresses to operation 214, where an indication of the transfer is provided (e.g., in response to the request that was received at operation 202). In examples, the indication includes the transfer identifier that was generated at operation 212, thereby enabling subsequent processing to be performed using the identifier accordingly. For example, a subsequent request to the transfer platform (e.g., via the API) may include the identifier to request a transfer status (e.g., as may be determined based on an associated state machine) or to generate a child transfer according to aspects described herein, among other examples. Method 200 terminates at operation 214.

Returning to determination 204, if it is instead determined that the source indication includes a transfer identifier (e.g., thereby indicating a destination account of a parent transfer is the source account for the requested transfer), flow instead branches “YES” to determination 216. At determination 216, it is determined (e.g., by a transfer group manager, such as transfer group manager 114 in FIG. 1) whether there is a pre-existing transfer group. As noted above, the determination may be based on the provided transfer identifier, as a pre-existing transfer group may have been generated to have an association with a transfer identifier (e.g., of the parent transfer for the transfer group). As another example, a graph datastore may be evaluated, wherein the indicated parent transfer corresponds to a transfer node in the graph datastore. In such an example, a set of relationships for the transfer node is evaluated to determine whether a relationship of the transfer node further associates the transfer node with another transfer node (or, in another example, to a transfer group node, which may itself be associated with a number of transfer nodes), thereby indicating that there is a preexisting transfer group within the graph datastore. Similarly, a table of a relational database may be evaluated to determine whether there is a pre-existing association between the parent transfer and another transfer (or, as another example, between the parent transfer and a transfer group). It will therefore be appreciated that any of a variety of techniques may be used to determine whether there is an existing transfer group corresponding to the indicated parent transfer.

If it is determined that there is not an existing transfer group, flow branches “NO” to operation 218, where a transfer group is generated accordingly. As noted above, an identifier of the source indication may be used as the identifier for the generated transfer group in some examples. In another examples, generating the transfer group comprises updating a graph datastore and/or a relational database to define a transfer group therein. Operation 218 may further comprise adding the parent transfer to the generated transfer group (e.g., by generating an association between the parent transfer and the transfer group accordingly). It will therefore be appreciated that any of a variety of techniques may be used to generate a transfer group according to aspects described herein. Flow then progresses to operation 220, which is discussed below in detail.

Returning to determination 216, if it is instead determined that there is an existing transfer group, flow branches “YES” to operation 220, where the transfer request is validated based on the parent transfer. In examples, operation 220 comprises processing the parent transfer according to one or more validation rules. It will be appreciated that any number of parent and/or child transfers may be evaluated at operation 220, for example relating only to an immediate parent (e.g., as may have been specified by the request to generate the transfer that was received at operation 202) or to multiple parent transfers (e.g., as may be the case when a validation rule determines whether a transfer group as a whole does not transfer more than was initially transferred to an initial source account for the transfer group). It will be appreciated that such validation rules are provided as examples and, in other examples, additional or alternative rules may be used.

Moving to determination 222, it is determined whether the validation performed at operation 220 was successful. Aspects of determination 208 may be similar to those discussed above with respect to determination 208 and are therefore not necessarily redescribed in detail. If it is determined that validation was not successful, flow branches “NO” to operation 210, where a failure indication is provided as discussed above.

However, if it is instead determined that validation was successful, flow branches “YES” to operation 224, where a transfer is generated with destination account of the parent transfer as the source account for the new transfer. In examples, operation 218 comprises associating the newly generated transfer with the transfer group (e.g., as may have been generated at operation 218 or may have already been pre-existing). Flow then progresses to operation 214, where an indication of the generated transfer is provided as was described above. As illustrated, method 200 terminates at operation 214 accordingly.

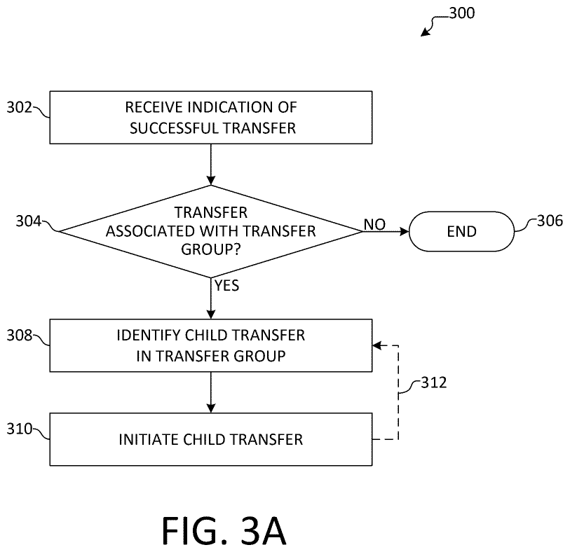

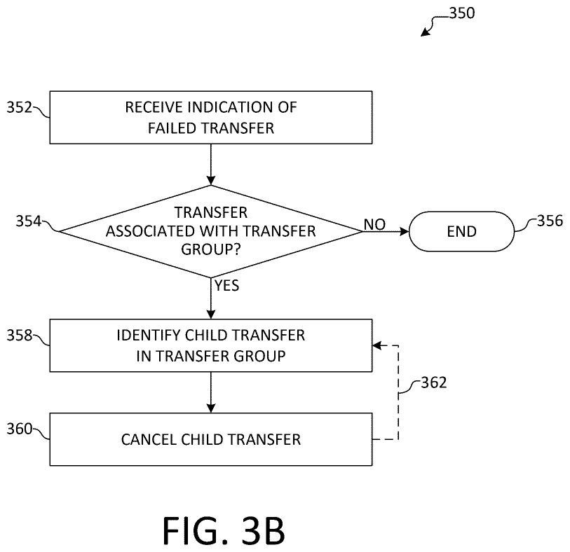

FIG. 3A illustrates an overview of an example method 300 for processing a transfer completion indication to initiate a child transfer according to aspects described herein. In examples, aspects of method 300 are performed by a transfer platform, such as transfer platform 102 discussed above with respect to FIG. 1.

As illustrated, method 300 begins at operation 302, where an indication of successful transfer completion is received. In examples, the indication of transfer completion is received via an event bus, for example as a result of a state machine (e.g., as may be managed by state machine manager 116 in FIG. 1) associated with a transfer being updated to reflect that the transfer has reached a completion state. It will be appreciated that, in other examples, any of a variety of additional or alternative techniques may be used to determine that a transfer has successfully completed, for example polling an API of a transaction agent (e.g., transaction agent 108 in FIG. 1), among other examples. In examples, a transfer is determined to have been completed once one or more constituent transactions have completed (e.g., as may each be associated with a transaction agent).

Flow progresses to determination 304, where it is determined whether the transfer is associated with a transfer group. As noted above, the determination may be based on identifying an association between a transfer node corresponding to the completed transfer and a transfer group or identifying an association indicated by a table of a relational database among other examples. In some instances, determination 304 comprises determining whether a transfer group having an identifier that is the same as or similar to the completed transfer exists, as may be the case when the transfer group was created based on a transfer identifier according to aspects described herein.

If it is determined that there is not an associated transfer group, flow branches “NO” and terminates at operation 306. However, if it is instead determined that there is an associated transfer group, flow branches “YES” to operation 308, where a child transfer is identified within the transfer group. Similar to determination 304, it will be appreciated that any of a variety of techniques may be used to identify an associated child transfer (e.g., as may be associated with the identified transfer group).

Moving to operation 308, a child transfer is identified within the transfer group. In examples, the child transfer is identified based on an order in which transfers were added to the transfer group (e.g., such that an oldest or newest transfer may be identified accordingly). It will be appreciated that any of a variety of other techniques may be used to identify a child transfer within the transfer group, for example based on a user-specified preference or set of rules, among other examples.

Flow progresses to operation 310 where, as a result of the transfer completion indication that was received at operation 302, the child transfer is initiated accordingly. Initiating the child transfer may comprise providing an indication of the transfer (e.g., including the source account, destination account, and amount) to a transaction agent and/or updating a state machine to indicate that the transfer is pending, among other examples. Arrow 312 illustrates that, in examples, method 300 includes a loop between 308 and 310, as may be the case when the parent transfer for which the indication of successful transfer completion was received has multiple child transfers. Thus, a successful parent transfer may thereby cause the initiation of multiple child transfers, in examples. As illustrated, method 300 ultimately terminates at operation 310. A subsequent iteration of method 300 may thus be performed when a child transfer that was initiated at operation 310 concludes, thereby initiating a further child transfer of the transfer group.

FIG. 3B illustrates an overview of an example method 350 for processing a transfer failure indication to cancel a child transfer according to aspects described herein. In examples, aspects of method 350 are performed by a transfer platform, such as transfer platform 102 discussed above with respect to FIG. 1.

As illustrated, method 350 begins at operation 352, where an indication of failed transfer completion is received. In examples, the indication of transfer failure is received via an event bus, for example as a result of a state machine (e.g., as may be managed by state machine manager 116 in FIG. 1) associated with a transfer being updated to reflect that the transfer has reached a failed state. It will be appreciated that, in other examples, any of a variety of additional or alternative techniques may be used to determine that a transfer has failed, for example polling an API of a transaction agent (e.g., transaction agent 108 in FIG. 1), among other examples.

Flow progresses to determination 354, where it is determined whether the transfer is associated with a transfer group. As noted above, the determination may be based on identifying an association between a transfer node corresponding to the completed transfer and a transfer group or identifying an association indicated by a table of a relational database among other examples. In some instances, determination 354 comprises determining whether a transfer group having an identifier that is the same as or similar to the completed transfer exists, as may be the case when the transfer group was created based on a transfer identifier according to aspects described herein.

If it is determined that there is not an associated transfer group, flow branches “NO” and terminates at operation 356. However, if it is instead determined that there is an associated transfer group, flow branches “YES” to operation 358, where a child transfer is identified within the transfer group. Similar to determination 354, it will be appreciated that any of a variety of techniques may be used to identify an associated child transfer (e.g., as may be associated with the identified transfer group).

Moving to operation 358, a child transfer is identified within the transfer group. In examples, the child transfer is identified based on an order in which transfers were added to the transfer group (e.g., such that an oldest or newest transfer may be identified accordingly). It will be appreciated that any of a variety of other techniques may be used to identify a child transfer within the transfer group, for example based on a user-specified preference or set of rules, among other examples.

Flow progresses to operation 360 where, as a result of the transfer failure indication that was received at operation 352, the child transfer is cancelled accordingly. Cancelling the child transfer may comprise updating a transfer data store and/or state machine to reflect that the transfer has been cancelled. In examples, as a result of cancelling the child transfer, a transfer identifier associated with the child transfer becomes unusable for generating a subsequent transfer using that transfer identifier as a source. It will be appreciated that any of a variety of alternative or additional operations may be performed at operation 360 to cancel the child transfer. Arrow 362 illustrates that, in examples, method 350 includes a loop between 358 and 360, as may be the case when the parent transfer for which the failure indication was received has multiple child transfers. Additionally, operations 358 and 360 may recurse through multiple branches of child transfers, thereby cancelling multiple tiers of child transfers that each ultimately depend from the failed parent transfer. As illustrated, method 350 ultimately terminates at operation 360.

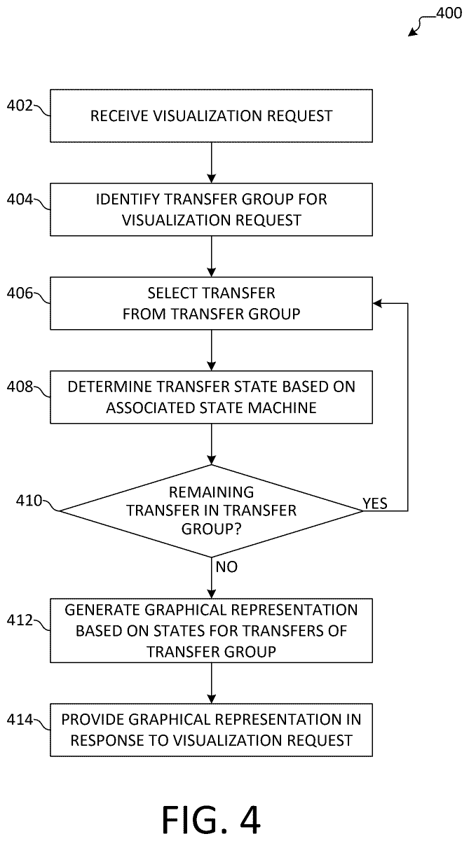

FIG. 4 illustrates an overview an example method 400 for generating a graphical visualization of a transfer group according to aspects described herein. In examples, aspects of method 400 are performed by a transfer platform, such as transfer platform 102 in FIG. 1. As another example, at least a part of the disclosed aspects are performed by a user computing device, such as user computing device 106 in FIG. 1.

As illustrated, method 400 begins at operation 402, where a visualization request is received. In examples, the visualization request is received as a result of a user operating an application on a user computing device (e.g., application 120 of user computing device 106 discussed above with respect to FIG. 1). The visualization request may be received via an API of a transfer platform, such as API 112 of transfer platform 102 discussed above with respect to FIG. 1.

At operation 404, a transfer group is identified for the visualization request. In examples, the request that was received at operation 402 includes an indication of the transfer group to be visualized, for example using an identifier (e.g., of the transfer group and/or a transfer therein), a source account, and/or a destination account, among other examples. While method 400 is described in an instance where a single transfer group is visualized, it will be appreciated that similar aspects may be used to visualize any number of transfer groups, for example as are associated with one or more given accounts.

Flow progresses to operation 406, where a transfer is selected from the transfer group. In examples, operation 406 comprises selecting transfers according to a hierarchy defined by the transfer group (e.g., where a parent transfer is selected before a child transfer). Additionally, or alternatively, transfers may be sorted according to creation time, completion time, and/or amount (e.g., for a set of transfers that each depend from the same parent or within the transfer group overall). In some examples, the request that was received at operation 402 includes a filter that is used to omit one or more transfers of the transfer group, for example to omit transfers that have since completed, that are not yet initiated, and/or that have failed, among other examples. Thus, it will be appreciated that any of a variety of techniques may be used to select a transfer group.

At operation 408, a transfer state is determined based on an associated state machine. As noted above, a state machine manager (e.g., state machine manager 116 in FIG. 1) maintains a status for transfers of a transfer platform, which is thus updated, for example, when a transfer is created, when a transfer is initiated, when a transfer is pending, and when a transfer has reached a terminal state, among any of a variety of additional or alternative examples. While method 400 is provided as an example in which a transfer group is evaluated to determine the state of transfers therein, it will be appreciated that any of a variety of additional or alternative evaluations may be performed, for example to generate a visualization of the flow transferred amounts (e.g., from the first, parent-most transfer of the group to the last, child transfers).

At determination 410, it is determined whether there is a remaining transfer in the transfer group. If it is determined that there is another transfer in the transfer group (e.g., as a result of evaluating a table in a relational database and/or one or more edges of a node in a graph data store), flow branches “YES” to operation 406, where another transfer is selected. Thus, method 400 iterates between operations 406, 408, and 410 to process transfers of a transfer group accordingly.

Eventually, flow branches “NO” from determination 410 to operation 412, where a graphical representation is generated based on states for transfers of the transfer group. As noted above, any of a variety of additional or alternative attributes may be used in other examples. In examples, the visual representation includes a tree, hierarchy, or other representation of how transfers of the transfer group are interrelated. In some instances, the transfers may be grouped, emphasized/deemphasized, and/or sorted according to a variety of criteria, as may have been specified as part of the request that was received at operation 402. Additionally, or alternatively, operation 412 comprises performing additional processing of one or more attributes that were determined at operation 408 for each respective transfer, for example to generate one or more aggregate attributes for a set of transfers (e.g., as may all directly and/or indirectly depend from a given parent transfer).

In some instances, the graphical representation is an interactive graphical representation, for example such that a user may actuate at least a part of the representation to affect what information is displayed and/or how the information is displayed. As an example, a graphical element corresponding to a parent transfer depicted within the graphical representation may interactive, such that user actuation of the graphical element causes one or more child transfers to be displayed/hidden accordingly. As another example, the graphical representation includes sorting/filtering functionality, such that the representation may be sorted and/or filtered after generation (e.g., by the user via the user's computing device).

Moving to operation 414, the generated graphical representation is provided in response to the visualization request that was received at operation 402. In examples, the graphical representation is provided as an image and/or software code (e.g., as may be parsed or otherwise processed to generate the graphical representation), among any of a variety of other formats. In some examples, the graphical representation may be provided via the API. As another example, the graphical representation is provided via a website of the transfer platform, such that it is displayed via a web browser of a client computing device.

While method 400 is described in an instance where the graphical representation is provided in response to a request, it will be appreciated that similar techniques may be used in instances where the graphical report is generated periodically or in response to an event (e.g., as a report). In examples, the graphical representation is provided as part of an electronic communication, for example in the body of a message or as an attachment to an email, among other examples. As illustrated, method 400 terminates at operation 414.

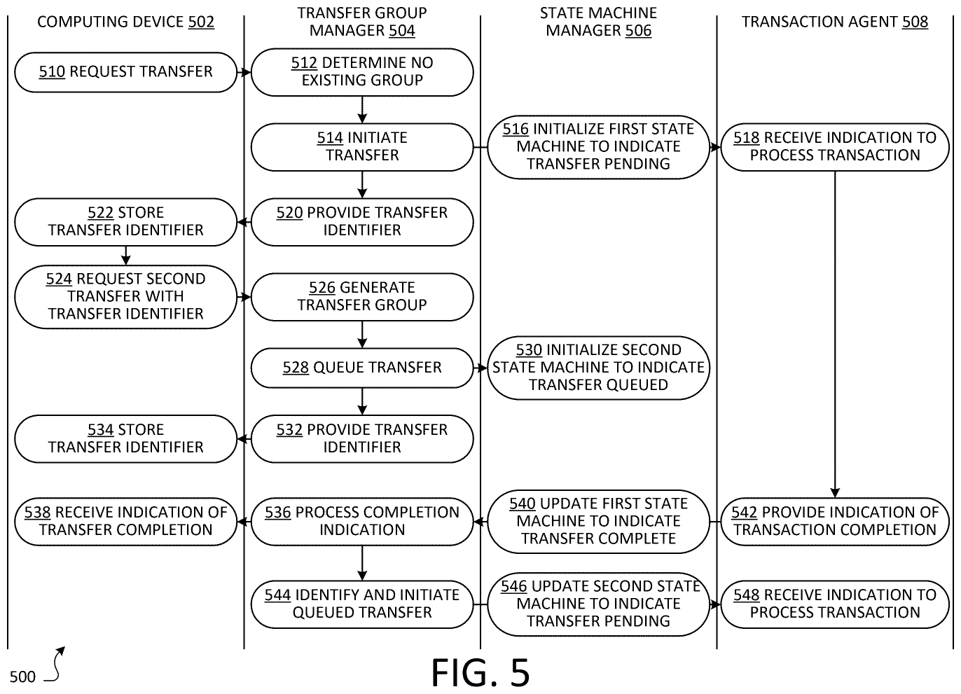

FIG. 5 illustrates an overview of an example process flow 500 for transfer grouping according to aspects described herein. As illustrated, process flow 500 occurs between computing device 502, transfer group manager 504, state machine manager 506, and transaction agent 508. Aspects of computing device 502, transfer group manager 504, state machine manager 506, and transaction agent 508 may be similar to user computing device 106, transfer group manager 114, state machine manager 116, and transaction agent 108, respectively, discussed above with respect to FIG. 1 and may therefore not necessarily be redescribed in detail.

As illustrated, flow 500 begins at operation 510, where computing device 502 requests a transfer. As noted above, the request may be made using an API in some examples. Accordingly, the request is received by transfer group manager 504, which determines, at operation 512, that there is no existing transfer group for the requested transfer. For instance, the request at operation 510 includes a source account, a destination account, and an amount, rather than indicating the identifier of an existing transfer in place of the source account.

Flow progresses to operation 514, where a transfer is initiated based on the request from computing device 502 at operation 510. As illustrated, initiating the transfer comprises providing an indication to transaction agent 508. Flow 500 is illustrated as an example where the transfer includes a single transaction, but it will be appreciated similar aspects may be used for a transfer having multiple constituent transactions (e.g., initiating each transaction via the same and/or different transaction agents). Transaction agent 508 receives the indication at operation 518, such that transaction agent 508 processes the requested transaction accordingly. Accordingly, state machine manager 506 initializes a state machine for the first transfer to indicate that the transfer is pending. Flow 500 is illustrated with an arrow passing through operation 516 to indicate that, in an example, operation 514 comprises generating an event via an event bus, such that the event is received and processed by both state machine manager 506 and transaction agent 508. It will be appreciated that any of a variety of other techniques may be used, for example such that transfer group manager 504 generates two indications (e.g., one to state machine manager 506 and another to transaction agent 508).

At operation 520, transfer group manager 504 provides a transfer identifier for the initiated transfer, which is thus received by computing device 502 and stored at operation 522. In examples, the transfer identifier is received in response to the request that was generated at operation 510. Subsequently, at operation 524, computing device 502 requests a second transfer, wherein the request comprises the transfer identifier associated with the first transfer. As noted above, the transfer identifier may be provided in place of a source account for the transfer, thereby indicating that the second transfer is to use the destination account of the first transfer as the source account accordingly.

As a result of including the transfer identifier as the source account, transfer group manager 504 generates a transfer group at operation 526, such that the first transfer is a parent transfer for the second transfer. At operation 528, the transfer is queued (e.g., as a result of the first transfer having not yet been completed) and, at operation 530, state machine manager 506 initializes a second state machine for the second transfer that indicates the second transfer has been queued. Similar to the first state machine for the first transfer, the second state machine may be initialized as a result of state machine manager 506 identifying an event on an event bus or, as another example, transfer group manager 504 provides an indication to state machine manager 506 to initialize/update the second state machine accordingly.

At operation 532, a transfer identifier is provided for the second transfer, which is thus received and stored by computing device 502 at operation 534. Aspects of operations 532 and 534 may thus be similar to those discussed above with respect to operations 520 and 522, respectively.

Eventually, transaction agent 508 provides an indication that the transaction for the first transfer has been completed at operation 542 such that, at operation 536, the completion indication is processed by transfer group manager 504 accordingly. In examples where multiple transactions form a transfer, the completion indication may be generated as a result of all transactions having completed successfully. Similar to operations 514, 516, and 518, the completion indication may be provided via an event bus, such that, at operation 540, state machine manager 506 updates the first state machine to reflect the completed transfer accordingly. As noted above, it will be appreciated that any of a variety of other techniques may be used such that state machine manager 506 determines to update the first state machine accordingly.

Processing the completion indication at operation 536 may comprise providing an indication of transfer completion to computing device 502, which is received at operation 538. Additionally, at operation 544 a queued (e.g., the second, child transfer) transfer is identified and initiated accordingly.

While flow 500 depicts operation 544 as occurring following operation 536, it will be appreciated that, in some examples, operation 544 may occur as a result of state machine manager 506 updating the first state machine to reflect that the transfer has been completed. For example, state machine manager 506 broadcasts an event via an event bus, which is thus received by transfer group manager 504, such that transfer group manager 504 evaluates a corresponding transfer group (e.g., as was generated at operation 526) to initiate a subsequent transfer accordingly.

As a result, transaction agent 508 receives an indication to process a transaction of the second transfer at operation 548, and state machine manager 506 updates the second state machine to indicate the transfer is pending accordingly. Flow 500 is illustrated as terminating at operation 548, but it will be appreciated that processing of the second transfer may thus proceed similar to processing of the first transfer as discussed above. Additionally, any number of subsequent transfers may similarly be processed according to such aspects.

It will be appreciated that any of a variety of techniques may be used to cause a subsequent transfer of a transfer group to be initiated following the completion of a parent transfer according to aspects described herein. Additionally, while flow 500 is illustrated as an example in which the first, parent transfer reaches a terminal state of completion, it will be appreciated that similar aspects may be used in instances where a transfer reaches a different terminal state. For instance, if the first transfer fails, transfer group manager 504 may instead identify the second, child transfer at operation 544 and cancel the second transfer accordingly, among other examples.

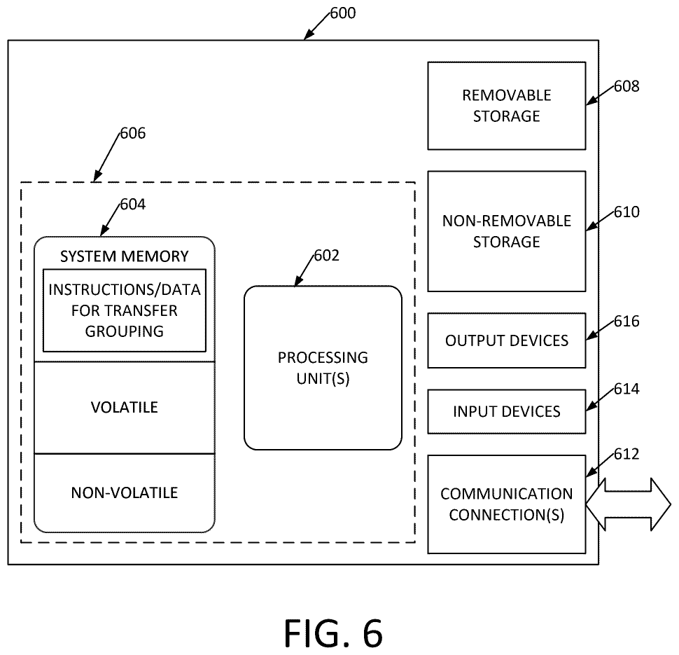

FIG. 6 illustrates an example of a suitable operating environment 600 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 600 typically may include at least one processing unit 602 and memory 604. Depending on the exact configuration and type of computing device, memory 604 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 6 by dashed line 606. Further, environment 600 may also include storage devices (removable, 608, and/or non-removable, 610) including, but not limited to, magnetic or optical disks or tape. Similarly, environment 600 may also have input device(s) 614 such as a keyboard, mouse, pen, voice input, etc. and/or output device(s) 616 such as a display, speakers, printer, etc. Also included in the environment may be one or more communication connections, 612, such as LAN, WAN, point to point, etc.

Operating environment 600 may include at least some form of computer readable media. The computer readable media may be any available media that can be accessed by processing unit 602 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 600 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 604. While executing on the processing unit 602, program modules (e.g., applications, Input/Output (I/O) management, and other utilities) may perform processes including, but not limited to, one or more of the stages of the operational methods described herein such as the methods illustrated in FIG. 2, 3A, 3B, 4, or 5, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 600 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system, comprising:
at least one processor; and
memory storing instructions that, when executed by the at least one processor, causes the system to perform a set of operations, the set of operations comprising:
receiving a first request to generate a first transfer, wherein the first request comprises a source account, a first destination account, and a first transfer amount;
generating a first transfer identifier for the first transfer;
providing an indication of the first transfer identifier;
receiving a second request to generate a second transfer, wherein the second request comprises the first transfer identifier, a second destination account, and a second transfer amount; and
generating, based on the first transfer identifier, a transfer group comprising the first transfer and the second transfer, wherein a source account for the second transfer is the first destination account of the first transfer.

2. The system of claim 1, wherein the set of operations further comprises:
determining that the first transfer has completed successfully; and
in response to determining that the first transfer has completed successfully, initiating the second transfer.

3. The system of claim 2, wherein:
a first state machine is initiated as a result of the first request to generate the first transfer to indicate the first transfer is pending; and
it is determined that the first transfer has completed successfully based on an update to the first state machine, thereby initiating the second transfer.

4. The system of claim 3, wherein a second state machine indicates the second transfer is queued in response to receiving the second request to generate the second transfer.

5. The system of claim 4, wherein the second state machine is updated to indicate the second transfer is pending in response to initiating the second transfer.

6. The system of claim 1, wherein the set of operations further comprises:
determining that the first transfer has completed successfully; and
in response to determining that the first transfer has completed successfully, initiating the second transfer.

7. The system of claim 1, wherein the set of operations further comprises:
receiving a third request to generate a third transfer, wherein the third request comprises a second transfer identifier corresponding to the second transfer, a third destination account, and a third transfer amount; and
updating, based on the second transfer identifier, the transfer group to include the third transfer as a dependent transfer from the second transfer, wherein a source account for the third transfer is the second destination account of the second transfer.

8. A method of managing a transfer of a transfer group, the method comprising:
determining, based on a first state machine associated with a first transfer, that the first transfer has reached a terminal state;
identifying, based on a transfer group associated with the first transfer, a second transfer associated with the first transfer; and
processing the second transfer based on the terminal state of the first transfer.

9. The method of claim 8, wherein the terminal state is a completion state and processing the second transfer comprises at least one of:
providing an indication to a transaction agent to initiate a transaction of the second transfer; and
updating a second state machine associated with the second transfer to indicate the second transfer is in a pending state.

10. The method of claim 8, wherein the terminal state is a failure state and processing the second transfer comprises at least one of:
cancelling the second transfer; and
updating a second state machine associated with the second transfer to indicate the second transfer has been cancelled.

11. The method of claim 8, wherein it is determined that the first transfer has reached a terminal state as a result of an event that is received via an event bus.

12. The method of claim 8, wherein a source account of the second transfer is a destination account of the first transfer.

13. The method of claim 8, further comprising:
identifying, based on the transfer group, a third transfer associated with the first transfer; and
contemporaneous with the processing of the second transfer, processing the third transfer based on the terminal state of the first transfer.

14. A method of managing a transfer group by a transfer platform, comprising:
receiving a first request to generate a first transfer, wherein the first request comprises a source account, a first destination account, and a first transfer amount;
generating a first transfer identifier for the first transfer;
providing an indication of the first transfer identifier;
receiving a second request to generate a second transfer, wherein the second request comprises the first transfer identifier, a second destination account, and a second transfer amount; and
generating, based on the first transfer identifier, the transfer group comprising the first transfer and the second transfer, wherein a source account for the second transfer is the first destination account of the first transfer.

15. The method of claim 14, further comprising:
determining that the first transfer has completed successfully; and
in response to determining that the first transfer has completed successfully, initiating the second transfer.

16. The method of claim 15, wherein:
a first state machine is initiated as a result of the first request to generate the first transfer to indicate the first transfer is pending; and
it is determined that the first transfer has completed successfully based on an update to the first state machine, thereby initiating the second transfer.

17. The method of claim 16, wherein a second state machine indicates the second transfer is queued in response to receiving the second request to generate the second transfer.

18. The method of claim 17, wherein the second state machine is updated to indicate the second transfer is pending in response to initiating the second transfer.

19. The method of claim 14, further comprising:
determining that the first transfer has completed successfully; and
in response to determining that the first transfer has completed successfully, initiating the second transfer.

20. The method of claim 14, further comprising:
receiving a third request to generate a third transfer, wherein the third request comprises a second transfer identifier corresponding to the second transfer, a third destination account, and a third transfer amount; and
updating, based on the second transfer identifier, the transfer group to include the third transfer as a dependent transfer from the second transfer, wherein a source account for the third transfer is the second destination account of the second transfer.
